(19) United States
(12) Patent Application Publication
(10) Pub. No.: US 2010/0169698 A1
(43) Pub. Date: Jul. 1, 2010

(54) RECORDING MEDIUM CONTROL ELEMENT, RECORDING MEDIUM CONTROL CIRCUIT BOARD, AND RECORDING MEDIUM CONTROL DEVICE

(75) Inventor: Masayoshi Murayama, Hanno-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/421,982

(22) Filed: Apr. 10, 2009

(30) Foreign Application Priority Data
Dec. 25, 2008 (JP) 2008-329993

(51) Int. Cl. G06F 1/06

(52) U.S. Cl. 713/501

(57) ABSTRACT

A recording medium control element includes: an input/output module configured to input/output a command and data to/from a recording medium; a first control module configured to control the input/output of the command and data performed by the input/output module; a buffer holding the data input/output to/from the input/output module; a second control module configured to control writing and reading data to/from the buffer; a clock generating module configured to generate a first clock signal and a second clock signal whose frequency is lower than a maximum operating frequency of the recording medium; and a signal supply module configured to supply the first clock signal to the recording medium and the input/output module, and supplying the second clock signal to the first and second control modules.

### CROSS-REFERENCE TO RELATED APPLICATIONS

This application is based upon and claims the benefit of priority from the prior Japanese Patent Application No. 2008-329993, filed on Dec. 25, 2008; the entire contents of which are incorporated herein by reference.

### BACKGROUND OF THE INVENTION

1. Field of the Invention

The present invention relates to a recording medium control element, a recording medium control circuit board, and a recording medium control device.

2. Description of the Related Art

There has been used a memory controller controlling writing and reading data to/from a recording medium such as SD card (registered trademark). Here, in a conventional memory controller, the entire memory controller operates by a system clock, and a frequency of the system clock is divided thereby generating a SD clock for SD card (registered trademark).

Note that there has been disclosed an art with regard to a memory controller generating clocks corresponding to various memory cards and supplying them (refer to JP-A 2007-299157 (KOKAI)).

### BRIEF SUMMARY OF THE INVENTION

In a conventional memory controller, a frequency of a system clock for the memory controller is higher than that of a SD clock (for example, twice). Therefore, it is difficult to reduce the frequency of the system clock, and furthermore to reduce power consumption of the memory controller.

An object of the present invention is to provide a recording medium control element, a recording medium control circuit board, and a recording medium control device in which reduction of power consumption is realized.

A recording medium control element according to one aspect of the present invention includes: an input/output module configured to input/output a command and data to/from a recording medium; a first control module configured to control the input/output of the command and data performed by the input/output module; a buffer holding the data input/output to/from the input/output module; a second control module configured to control writing and reading data to/from the buffer; a clock generating module configured to generate a first clock signal and a second clock signal whose frequency is lower than a maximum operating frequency of the recording medium; and a signal supply module configured to supply the first clock signal to the recording medium and the input/output module, and supplying the second clock signal to the first and second control modules.

A recording medium control circuit board according to one aspect of the present invention includes: a first input/output module configured to input/output a command and data to/from a host device; a second input/output module configured to input/output a command and data to/from a recording medium; a first control module configured to control the input/output of the command and data performed by the second input/output module based on the command and data input/output to/from the first input/output module; a buffer holding the data input/output to/from the first and second input/output modules; a second control module configured to control writing and reading data to/from the buffer; a clock generating module configured to generate a first clock signal and a second clock signal whose frequency is lower than a maximum operating frequency of the recording medium; and a signal supply module configured to supply the first clock signal to the recording medium and the first and second input/output modules, and supplying the second clock signal to the first and second control modules.

A recording medium control device according to one aspect of the present invention includes: a device main body; a first input/output module configured to input/output a command and data to/from the device main body; a second input/output module configured to input/output a command and data to/from a recording medium; a first control module configured to control the input/output of the command and data performed by the second input/output module based on the command and data input/output to/from the first input/output module; a buffer holding the data input/output to/from the first and second input/output modules; a second control module configured to control writing and reading data to/from the buffer; a clock generating module configured to generate a first clock signal and a second clock signal whose frequency is lower than a maximum operating frequency of the recording medium; and a signal supply module configured to supply the first clock signal to the recording medium and the first and second input/output modules, and supplying the second clock signal to the first and second control modules.

### BRIEF DESCRIPTION OF THE DRAWINGS

FIG. 1 is a block diagram showing a memory system 100 according to one embodiment of the present invention.

### DETAILED DESCRIPTION OF THE INVENTION

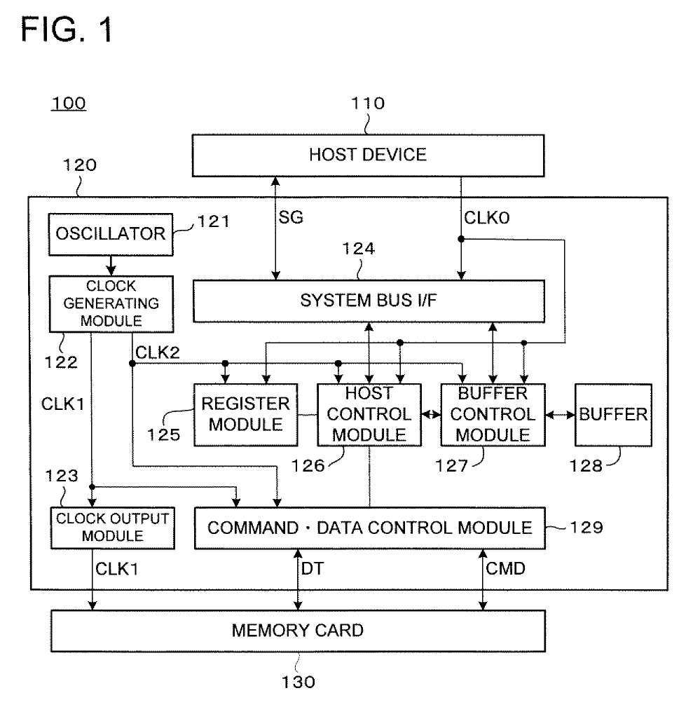

Hereinafter, an embodiment of the present invention will be explained in details with reference to the drawing. FIG. 1 is a block diagram showing a memory system 100 according to one embodiment of the present invention. The memory system 100 has a host device 110, a memory controller 120, and a memory card 130, and functions as a recording medium control device.

The host device 110 is a device for writing/reading data to/from the memory card 130 via the memory controller 120, which is, for example, a personal computer (a PC). The host device 110 functions as a device main body. The host device 110 has a system bus (not shown) connected to the memory controller 120 (in particular, a later-described system bus I/F 124), and performs a data transfer request and data transfer to the memory controller 120 by a system bus interface (I/F) signal SG. Further, the host device 110 outputs a bus clock CLK0 to the memory controller 120 for synchronization with transmission/reception of a signal to/from the memory controller 120.

The memory controller 120 is a device for controlling writing/reading data to/from the memory card 130. The memory card 130 is a recording medium, for example, SD card (registered trademark).

The memory controller 120 can be formed by a circuit board. In this case, this circuit board can function as a recording medium control circuit board. Further, the memory controller 120 can be configured by a semiconductor element (an IC, or the like). In this case, this semiconductor element can function as a recording medium control element.

The memory controller 120 has an oscillator 121, a clock generating module 122, a clock output module 123, the system bus interface (I/F) 124, a register module 125, a host control module 126, a buffer control module 127, a buffer 128, and a command data control module 129.

The oscillator 121 generates reference frequency signals being a reference of clocks CLK1, CLK2 generated in the clock generating module 122.

The clock generating module 122 generates the clocks CLK1, CLK2 from the reference frequencies generated in the oscillator 121. Each of the clocks CLK1, CLK2 is a memory clock for the memory card 130 and a system clock for internal processing in the memory controller 120. Each of the frequencies of the clocks CLK1, CLK2 is generated by dividing each reference frequency based on setting in the register module 125. The clock generating module 122 has a divider for generating each of the clocks CLK1, CLK2.

The frequency of the clock CLK1 is selected within a range from an initialization frequency to a maximum operating frequency of the memory card 130. The initialization frequency is a frequency for initialization of the memory card 130. In initializing the memory card 130, for example, SD card, the initialization frequency smaller than an operating frequency is used.

As for the frequency of the clock CLK2, a value smaller than the maximum operating frequency of the memory card 130 (or the frequency of the clock CLK1) is selected.

The clock CLK1 is supplied to the clock output module 123 and the command•data control module 129. On the other hand, the clock CLK2 is supplied to the register module 125, the host control module 126, and the buffer control module 127.

Note that the bus clock CLK0 is also supplied to the register module 125, the host control module 126, and the buffer control module 127. The reason thereof is as follows.

One register (a register for setting operation of various controllers from the host device 110) in the register module 125 operates by the bus clock CLK0.

The bus clock CLK0 is used for inputting/outputting data and the like between the host control module 126 and the system bus I/F 124. Note that input/output between the host control module 126 and the command•data control module 129 is controlled by the clock CLK2.

The bus clock CLK0 is used for inputting/outputting data and the like between the buffer control module 127 and the system bus I/F 124.

Further, the clock CLK2 is also supplied to the command•data control module 129. Input/output between the command•data control module 129 and the host control module 126 is controlled by the clock CLK2.

The clock output module 123 controls output and an output stop of the clock CLK1 to the memory card 130.

The system bus I/F 124 operates by the bus clock CLK0, and transmits/receives the system bus I/F signal SG through the system bus in the host device 110. Further, the system bus I/F 124 inputs/outputs data and the like to/from the host control module 126 and the buffer control module 127. That is, the system bus I/F 124 mediates transmission/reception of an access request to the memory card 130 and data between the host device 110 and the host control module 126 (and the buffer control module 127). The system bus I/F 124 functions as a first input/output module configured to input/output a command and data to/ from the device main body.

The register module 125 is a register group setting operation of the memory controller 120. Each of the frequencies of the clocks CLK1, CLK2 can be set by the register module 125. The register module 125 basically operates by the clock CLK2. However, one register (the register for setting operation of the various controllers from the host device 110) in the register module 125 operates by the bus clock CLK0.

The host control module 126 mediates transmission/reception of data and the like between the host device 110 and the memory card 130. The host control module 126 performs reception of the access request to the memory card 130 from the host device 110 and notification of various statuses and interruption via the system bus I/F 124. The host control module 126 controls transmission of a memory card command CMD to the memory card 130, response reception, data transfer, and the like performed by the command•data control module 129.

The host control module 126 transmits/receives data to/from the buffer control module 127.

The host control module 126 basically operates by the clock CLK2. However, input/output between the host control module 126 and the system bus I/F 124 is controlled by the bus clock CLK0. The host control module 126 functions as a first control module configured to control input/output of a command and data performed by a second input/output module.

The buffer control module 127 controls writing and reading data to/from the buffer 128. Further, the buffer control module 127 inputs/outputs data to/from the host control module 126 and the system bus I/F 124. The buffer control module 127 functions as a second control module configured to control writing and reading data to/from the buffer 128.

The buffer control module 127 basically operates by the clock CLK2. However, input/output between the buffer control module 127 and the system bus I/F 124 is controlled by the bus clock CLK0.

The buffer 128 holds block size data temporarily therein in transferring data to/from the memory card 130. This block size can be set appropriately. For example, the block size of the buffer 128 is set corresponding to the block size of the memory card 130. As one example, in the case of the block size of the memory card 130 being 512 bytes, the block size of the buffer 128 is also set to be 512 bytes.

The buffer 128 has two ports as an interface, and makes parallel access from both of the system bus I/F 124 and the host control module 126 possible. For example, reading data from the memory card 130 and transferring data to the host device 110 are performed in parallel.

The command•data control module 129 is controlled by the host control module 126, and transmits/receives the memory card command CMD, a response, and data DT to/from the memory card 130. The command•data control module 129 basically operates by the clock CLK1. However, the command•data control module 129 operates by the clock CLK2 in input/output to/from the host control module 126. The command•data control module 129 functions as the second input/output module configured to input/output a command and data to/from the recording medium.

### (Operation of the Memory System 100)

Hereinafter, the operation of the memory system 100 will be explained.

### (1) Transmission/Reception of an Issue Request of the Memory Card Command CMD

The host device 110 sets the register module 125 in the memory controller 120 by using the system bus I/F signal SG. Thereafter, the host device 110 transmits the issue request of the memory card command CMD by using the system bus I/F signal SG. The host control module 126 in the memory controller 120 receives the issue request of the memory card command CMD from the host device 110 via the system bus I/F 124.

### (2) Issue of the Memory Card Command CMD

Based on the issue request of the memory card command CMD, the host control module 126 in the memory controller 120 controls the command•data control module 129. As a result, the command•data control module 129 issues the memory card command CMD. The command•data control module 129 transmits the memory card command CMD to the memory card 130 to receive a response therefrom.

### (3) Data Transfer Based on the Memory Card Command CMD

Here, the case when the memory card command CMD to be issued is accompanied with the data transfer request will be considered.

a. Case of Data Transfer from the Host Device 110 to the Memory Card 130

When this data transfer is a write transfer to the memory card 130 (data transfer from the host device 110 to the memory card 130), the host device 110 sends block size data (block data) to the buffer control module 127 via the system bus I/F 124 to write it in the buffer 128.

The block data written in the buffer 128 is sent to the command•data control module 129 via the buffer control module 127 and the host control module 126. The command•data control module 129 converts byte data into bit data (for example, 1, 2, or 4 bits) to output it to the memory card 130 through a data bus.

b. Case of Data Transfer from the Memory Card 130 to the Host Device 110

When the data transfer is a read transfer from the memory card 130 (data transfer from the memory card 130 to the host device 110), the command•data control module 129 receives bit data (for example, 1, 2, or 4 bits) from the memory card 130. The command•data control module 129 converts this data into byte data to send it to the buffer control module 127 via the host control module 126. The buffer control module 127 writes block size data in the buffer 128. The host device 110 reads the block size data from the buffer 128 via the buffer control module 127 and the system bus I/F 124.

As described above, the command•data control module 129 operates by the clock CLK1. On the other hand, the register module 125, the host control module 126, and the buffer control module 127 basically operate by the clock CLK2.

Here, it becomes possible to make the frequency of the clock CLK2 lower than that of the clock CLk1. This is because a data width inside the memory controller 120 (for example, between the buffer control module 127 and the command data control module 129) is larger than that of the data bus in the memory card 130. For example, in the case when the data width of the data bus in the memory card 130 is 4 bits, two clocks are required in order to transfer 1 byte data. The data width between the buffer control module 127 and the command•data control module 129 is set to be 1, 2, or 4 bytes. That is, data is processed in a unit of 1, 2, or 4 bytes.

In the case when data is transferred between the buffer control module 127 and the command•data control module 129 in a unit of 1 byte, data is transferred once in two clocks of the clock CLK1. In the case when data is transferred between the buffer control module 127 and the command•data control module 129 in a unit of 2 or 4 bytes, data is transferred once in four or eight clocks of the clock CLK1.

As above, it becomes possible to make the register module 125, the host control module 126, and the buffer control module 127 operate by the clock CLK2 whose frequency is, for example, ½, ¼, or ⅛ of the frequency of the clock CLK1. That is, the frequency of the clock CLK2 can be selected appropriately corresponding to a unit transfer amount (the data width) in the buffer 128 and the frequency of the clock CLK1.

In the above example, the frequency of the clock CLK1 is set to be a power of two (2ⁿ=2, 4, or 8) of the frequency of the clock CLK2. However, it is also possible to set the frequency of the clock CLK1 to be three times, 3/2 times, or the like that of the clock CLK2.

As described above, in this embodiment, it is set that the command•data control module 129 operates by the clock CLK1, and the other circuits (the register module 125, the host control module 126, and the buffer control module 127) basically operate by the clock CLK2. That is, most of the circuits in the memory controller 120 operate by the clock CLK2 whose frequency is lower than a maximum frequency of the clock CLK1. That is, the frequency of the clock CLK2 is not required to be double the frequency of the clock CLK1. Accordingly, since the frequency of the clock CLK2 can be smaller than that of the clock CLK1, lower power consumption in the memory controller 120 can be realized.

In the above embodiment, the following advantage can be enjoyed.

It becomes possible to make control circuits inside the memory controller 120 operate by a frequency lower than the maximum operating frequency of the memory card 130 (it becomes possible to set the frequency of the clock CLK2 to be smaller than that of the clock CLK1). Therefore, by setting the operating frequency of the memory card 130 appropriately, power consumption in the memory controller 120 can be reduced.

Without changing a data transfer speed (a transfer speed between the host device 110 and the memory card 130) inside the memory controller 120, power consumption in the memory controller 120 can be small.

Since it is not necessary to make the frequencies of the clock CLK2 (the system clock) twice as large as that of the clock CLK1 (the clock for the memory card 130), it becomes easy to respond to a speed up of the clock CLK1.

### Other Embodiments

Embodiments of the present invention are not limited to the above-described embodiment but can be expanded and/or modified, and expanded or modified embodiments are also included in the technical scope of the present invention.

What is claimed is:

1. A recording medium control element, comprising:
an input/output module configured to input/output a command and data to/from a recording medium;
a first control module configured to control the input/output of the command and data performed by the input/output module;
a buffer holding the data input/output to/from the input/output module;
a second control module configured to control writing and reading data to/from the buffer;
a clock generating module configured to generate a first clock signal and a second clock signal whose frequency is lower than a maximum operating frequency of the recording medium; and
a signal supply module configured to supply the first clock signal to the recording medium and the input/output module, and supplying the second clock signal to the first and second control modules.

2. The recording medium control element of claim 1, further comprising,
a register module configured to control frequencies of the first and second clock signals generated in the clock generating module,
wherein the signal supply module supplies the second clock signal to the register module.

3. The recording medium control element of claim 1,
wherein the frequency of the first clock signal is larger than that of the second clock signal.

4. The recording medium control element of claim 1,
wherein the clock generating module includes first and second generating sections generating the first and second clock signals respectively.

5. A recording medium control circuit board, comprising:
a first input/output module configured to input/output a command and data to/from a host device;
a second input/output module configured to input/output a command and data to/from a recording medium;
a first control module configured to control the input/output of the command and data performed by the second input/output module based on the command and data input/output to/from the first input/output module;
a buffer holding the data input/output to/from the first and second input/output modules;
a second control module configured to control writing and reading data to/from the buffer;
a clock generating module configured to generate a first clock signal and a second clock signal whose frequency is lower than a maximum operating frequency of the recording medium; and
a signal supply module configured to supply the first clock signal to the recording medium and the first and second input/output modules, and supplying the second clock signal to the first and second control modules.

6. The recording medium control circuit board of claim 5, further comprising,
a register module configured to control frequencies of the first and second clock signals generated in the clock generating module,
wherein the signal supply module supplies the second clock signal to the register module.

7. The recording medium control circuit board of claim 5,
wherein the frequency of the first clock signal is larger than that of the second clock signal.

8. The recording medium control circuit board of claim 5,
wherein the clock generating module includes first and second generating sections generating the first and second clock signals respectively.

9. A recording medium control device, comprising,
a device main body;
a first input/output module configured to input/output a command and data to/from the device main body;
a second input/output module configured to input/output a command and data to/from a recording medium;
a first control module configured to control the input/output of the command and data performed by the second input/output module based on the command and data input/output to/from the first input/output module;
a buffer holding the data input/output to/from the first and second input/output modules;
a second control module configured to control writing and reading data to/from the buffer;
a clock generating module configured to generate a first clock signal and a second clock signal whose frequency is lower than a maximum operating frequency of the recording medium; and
a signal supply module configured to supply the first clock signal to the recording medium and the first and second input/output modules, and supplying the second clock signal to the first and second control modules.

10. The recording medium control device of claim 9, further comprising,
a register module configured to control frequencies of the first and second clock signals generated in the clock generating module,
wherein the signal supply module supplies the second clock signal to the register module.

11. The recording medium control device of claim 9,
wherein the frequency of the first clock signal is larger than that of the second clock signal.

12. The recording medium control device of claim 9,
wherein the clock generating module includes first and second generating sections generating the first and second clock signals respectively.
